(19) United States
(12) Patent Application Publication
(10) Pub. No.: US 2004/0248487 A1
(43) Pub. Date: Dec. 9, 2004

(54) Warmth-retaining fabric

(76) Inventor: Ryo Yasumitsu, Ibaraki-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/491,019

(22) PCT Filed: Sep. 11, 2002
(86) PCT No.: PCT/JP02/09299

(30) Foreign Application Priority Data
Sep. 26, 2001 (JP) 2001-293299

(51) Int. Cl. B32B 27/04

(52) U.S. Cl. 442/131; 442/59

(57) ABSTRACT

A warmth-retaining fabric of the present invention comprises at least one warmth-retaining layer formed on at least one surface of a substrate made of a fabric with a coverage of 30 to 85% of the surface and containing an infra-red ray-absorber and a binder resin, wherein, in repeating units of a pattern formed from the warmth-retaining layer and exposed-portions of the substrate not coated by the warmth-retaining layers, and repeated in at least one direction of the longitudinal and transverse directions of the substrate, the warmth-retaining layer has at least one continuous region having an area corresponding to 25% or more of the total area of the warmth-retaining layer, and the continuous regions of the warmth-retaining layers in the repeating pattern units adjacent each other in at least one direction of the longitudinal and transverse directions are continuous with each other, and has a similar hand to that of the substrate, a light color and excellent infrared ray-absorbing and warmth-retaining properties.

### FIELD OF INVENTION

The present invention relates to a fabric excellent in a warmth-retaining effect. More particularly, the present invention relates to a warmth-retaining fabric having an improved warmth-retaining effect without impairing the hand thereof and useful for clothing, that is necessary an enhanced warmth-retaining property.

### BACKGROUND ART

In order to enhance the warmth-retaining property of fiber products, means of increasing the thickness of the fiber products, means of increasing the structure density of the fiber product, or means of dyeing the fiber fabric in a dark color has heretofore been adopted generally.

Furthermore, in order to further enhance the warmth-retaining property of the fabric it has been proposed in recent years to produce the fabric from synthetic fibers into which fine ceramic carbide or nitride particles are mixed by kneading. However, such warmth-retaining fabrics have the following problems. That is, because fine ceramic particles having high hardness are mixed into fibers, by kneading, the original feeling of the synthetic fibers is impaired. The fine ceramic particles mixed into the synthetic fibers absorb not only infrared rays but also visible rays, and as a result, the synthetic fibers are colored. In order to make the coloring of the fibers with the fine ceramic particles less pronounced, the fibers must be colored to a dark color.

On the other hand, it has also been proposed to absorb heat rays in the sunlight with the back surface of a fabric by distributing an infrared ray absorber over the entire back surface of the fabric (for example, see Japanese Unexamined Patent Publication (Kokai) No. 8-325478). However, this method has the following problems. Although the fabric thus obtained exhibits good heat retention, the fabric has a stiff hand due to uniform distribution of an infrared ray absorber on the back surface of the fabric. Use of an infrared ray absorber causes the production cost to be increased, and the production becomes economically disadvantageous.

### DISCLOSURE OF THE INVENTION

The present invention is intended to provide a warmth-retaining fabric capable of converting sunlight energy into thermal energy with high efficiency without impairing the original hand of the fabric, having a high resistance to discoloration and exhibiting an excellent warmth-retaining property.

The warmth-retaining fabric of the present invention comprises a substrate comprising a fabric, and at least one warmth-retaining layer coated on at least one surface of the substrate with a coverage of 30 to 85% of the substrate surface area and comprising an infra-red ray-absorber and a binder resin, wherein

in repeating units of a pattern constituted from the warmth-retaining layer and exposed-portions of the substrate not coated by the warmth-retaining layer and repeated in at least one direction of the longitudinal and transverse directions of the substrate, the warmth-retaining layer has at least one continuous region having an area corresponding to 25% or more of the total area of the warmth-retaining layer, and the continuous regions of the warmth-retaining layers in the repeating pattern units adjacent each other in at least one direction of the longitudinal and transverse directions are continued to each other.

In the warmth-retaining fabric of the present invention, preferably the repeating unit of the pattern contains one or more exposed portions of the substrate, and the exposed portions are not continued to each other in at least one direction of the longitudinal and transverse directions of the repeating units.

In the warmth-retaining fabric of the present invention, the non-continuous regions of the exposed portions of the substrate are preferably distributed in the number of at least one per unit area of 10 cm×10 cm of the surface of the substrate.

In the warmth-retaining fabric of the present invention, the warmth-retaining layer is preferably formed on only one surface of the substrate.

In the warmth-retaining fabric of the present invention, the infra-red ray-absorber preferably has a thermal conductivity of 10 W/m·K or more, determined at a temperature of 27° C.

In the warmth-retaining fabric of the present invention, the infra-red ray-absorber preferably comprises fine particles of at least one member selected from infra-red ray-absorbing metal oxides, carbon black and infra-red ray-absorbing, coloring organic compound materials.

In the warmth-retaining fabric of the present invention, the infra-red ray-absorbing metal oxide fine particles are preferably selected from fine particles of antimony-doped tin oxide and tin-doped indium oxide having an average particle size of 100 nm or less.

In the warmth-retaining fabric of the present invention, the infra-red ray-absorber is preferably contained in a content in the range of 0.02 to 50 g/m² in the warmth-retaining layer on the surface of the substrate.

In the warmth-retaining fabric of the present invention, the mass ratio of the infra-red ray-absorber to the binder resin contained in the warmth-retaining layer is preferably in the range of 1:0.5 to 1:50.

In an embodiment of the warmth-retaining fabric of the present invention, in the repeating pattern unit on the surface of the substrate, the warmth-retaining layer is in the form of a continuous lattice pattern constituted from a plurality of longitudinal stripes extending in parallel to each other in the longitudinal direction of the substrate and a plurality of transverse strips extending in parallel to each other in the transverse direction of the substrate and intersecting the longitudinal stripes.

### BRIEF DESCRIPTION OF THE DRAWINGS

FIG. 1 is an explanatory drawing showing one example of a repeating unit of a pattern of the configuration of the warmth-retaining layer and exposed portions of the substrate in a warmth-retaining fabric of the present invention.

FIG. 2 is an explanatory drawing showing another example of a repeating unit of a pattern of the configuration of the warmth-retaining layer and exposed portions of the substrate in a warmth-retaining fabric of the present invention.

In FIG. 3, FIG. 3(A) is an explanatory drawing showing still another example of a repeating unit of a pattern of the configuration of the warmth-retaining layer and exposed portions of the substrate in a warmth-retaining fabric of the present invention, and FIG. 3 (B) is an explanatory drawing showing the configuration pattern when the repeating unit of FIG. 3(A) is repeated in the longitudinal and transverse directions.

FIG. 4 is an explanatory drawing showing still another example of a pattern of the configuration of the warmth-retaining layer and the exposed portions of the substrate in the warmth-retaining fabric of the present invention.

FIG. 5 is an explanatory drawing showing still another example of a pattern of the configuration of the warmth-retaining layers and the exposed portions of the substrate in the warmth-retaining fabric of the present invention.

FIG. 6 is an explanatory drawing showing still another example of a pattern of the configuration of the warmth-retaining layer and the exposed portions of the substrate in the warmth-retaining fabric of the present invention.

In FIG. 7, FIG. 7(A) is an explanatory drawing showing one example of a repeating unit of a pattern of the configuration of the warmth-retaining layer and the exposed portion of the substrate in a warmth-retaining fabric differing from the present invention, and FIG. 7 (B) is an explanatory drawing showing a configuration pattern when the repeating unit shown in FIG. 7(A) is repeated in the longitudinal and transverse directions.

### BEST MODE FOR CARRYING OUT THE INVENTION

The warmth-retaining fabric of the present invention comprises a substrate composed of a fabric and a warmth-retaining layer with which at least one surface of the substrate is coated in a surface coverage of the warmth-retaining layer of from 30 to 85% based on the entire surface area of the substrate, and which layer comprises an infrared ray absorber and a binder resin. The surface coverage ratio of the warmth-retaining layer based on the entire surface area of the substrate can be calculated from the following formula:

surface coverage of warmth-retaining layer(%)=A/(A+B)×100

wherein A is a total area of the warmth-retaining layer with which the substrate is coated, and B is a total area of exposed portions of the substrate.

A pattern formed from the shape and configuration of the warmth-retaining layer and the exposed portions of the substrate not coated with the warmth-retaining layer is repeatedly formed in at least one direction of the longitudinal and transverse directions of the substrate. There is no specific limitation to the repeating unit of pattern. However, in the repeating unit of a pattern, the warmth-retaining layer must have at least one continuous region having an area of 25% or more, more preferably 40% or more, still more preferably from 50 to 100%, based on the total area of the warmth-retaining layer.

The proportion of the continuous regions in the warm-retaining layer is calculated from the following formula:

Proportion of continuous regions of the warmth-retaining layer(%)=Aₐ/A_{b}×100

wherein Aₐ is a total area of the continuous regions in the warmth-retaining layer in the repeating unit of a pattern, and A_{b} is a total area of the warmth-retaining layer.

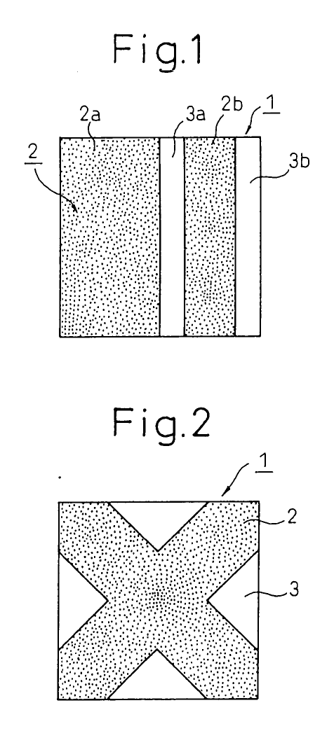

FIGS. 1 to 6 show examples of a repeating unit of a pattern formed by the warmth-retaining layer and exposed portions of the substrate in the warmth-retaining fabric of the present invention.

A repeating unit of a pattern of a warmth-retaining fabric 1 of the present invention, shown in FIG. 1, comprises a warmth-retaining layer 2 composed of two stripe-formed continuous regions 2a, 2b extending in the longitudinal direction (in the up-to-down direction in FIG. 1) of the fabric 1 and two stripe-formed exposed portions 3a, 3b of the substrate located on the left sides of the stripe-formed continuous regions 2a, 2b, respectively and extending in the longitudinal direction. The pattern is repeatedly formed in the longitudinal direction of the fabric 1, and the repeating unit may also be repeated twice or more in the transverse direction.

In the repeating unit of a pattern shown in FIG. 1, the stripe-formed continuous regions 2a, 2b in the warmth-retaining layer 2 extend in the longitudinal direction of the fabric 1. The stripe-formed continuous regions may also extend in the transverse direction to form another pattern. In the repeating unit of a pattern in FIG. 1, the ratio of a total area of the continuous regions 2a, 2b of the warmth-retaining layer 2 to the entire area of the repeating unit, namely, the surface coverage is 75%. The stripe-formed continuous regions 2a, 2b in the repeating unit in FIG. 1 are continued to other stripe-formed continuous regions respectively, of another repeating unit adjacent to the repeating unit shown in FIG. 1 in the longitudinal direction; and this continuity is repeated. The two exposed portions 3a, 3b of the substrate in the repeating unit of a pattern in FIG. 1 are not continued to exposed portions of the substrate in another repeating unit adjacent to the repeating unit shown in FIG. 1 in the transverse direction. For the repeating unit of the pattern, the ratio of an area of each of the stripe-formed continuous regions 2a and 2b to a total area of the warmth-retaining layer is 66.7% and 33.3%, respectively.

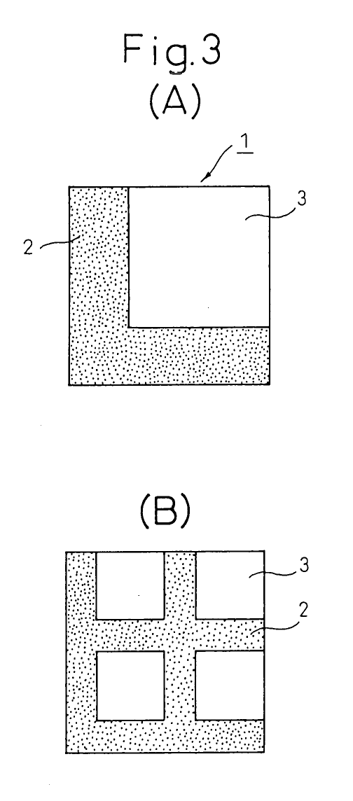

A repeating unit of a pattern of a warmth-retaining fabric 1 of the present invention shown in FIG. 2 comprises a warmth-retaining layer 2 composed of one oblique cross shaped continuous region that is formed from two stripes extending in two directions intersecting each other and the longitudinal direction of the fabric at intersecting angles of 45°, and four triangular exposed portions 3 of the substrate defined by the intersecting portions of the continuous regions. In the repeating unit of the pattern in FIG. 2, the ratio of an area of the warmth-retaining layer to a total area of the repeating unit of the pattern, namely, the surface coverage is 75%, and the entire warmth-retaining layer forms a continuous region.

The oblique cross-shaped warmth-retaining layer in the repeating unit of the pattern in FIG. 2 is continued to other oblique cross-shaped warmth-retaining layers of repeating units of the pattern adjacent to the repeating unit shown in FIG. 2 in the longitudinal and transverse directions to form an oblique lattice pattern.

Each of the four triangular exposed portions 3 of the substrate in the repeating unit of the pattern shown in FIG. 2 is continued to one triangular exposed portion 3 of the substrate in a repeating unit of a pattern adjacent to the repeating unit of FIG. 2 in the longitudinal or transverse direction to form one rhombic exposed substrate portion. The rhombic exposed portion of the substrate is surrounded by an oblique cross-shaped warmth-retaining layer to be isolated in an island form, and it is never continued to another rhombic exposed portions of the substrate.

The oblique cross-shaped warmth-retaining layer of FIG. 2 forms an integrated continuous region, and the ratio of the area of the continuous region to the entire area of the warmth-retaining layer is 100%.

In a repeating unit of pattern of a warmth-retaining fabric shown in FIG. 3(A), a fabric 1 comprises a warmth-retaining layer 2 composed of one continuous region formed in an L-shape on the substrate, and a square exposed portion 3 of the substrate adjacent to the warmth-retaining layer 2. The ratio of the area of the warmth-retaining layer 2 to the entire area of the repeating unit of a pattern, namely, the surface coverage, is 50%. When the repeating unit of the pattern shown in FIG. 3(A) is repeated in the longitudinal and transverse directions, an L-shaped warmth-retaining layer 2 in each of the repeating units of the pattern is continued to each other in the longitudinal and transverse directions to form a warmth-retaining layer 2 forming a lattice continuous region composed of longitudinal and transverse stripes intersecting each other as shown in FIG. 3(B). The exposed portion 3 of the substrate in each the repeating units of the pattern is surrounded by the lattice warmth-retaining layers 2 to be isolated in an island state. As a result, the exposed substrate portion 3 of the substrate is never continued to another one in the longitudinal and transverse directions. The lattice warmth-retaining layer 2 forms an integrated continuous region, and the ratio of the area of the integrated continuous region to the area of the entire warmth-retaining layer is 100%.

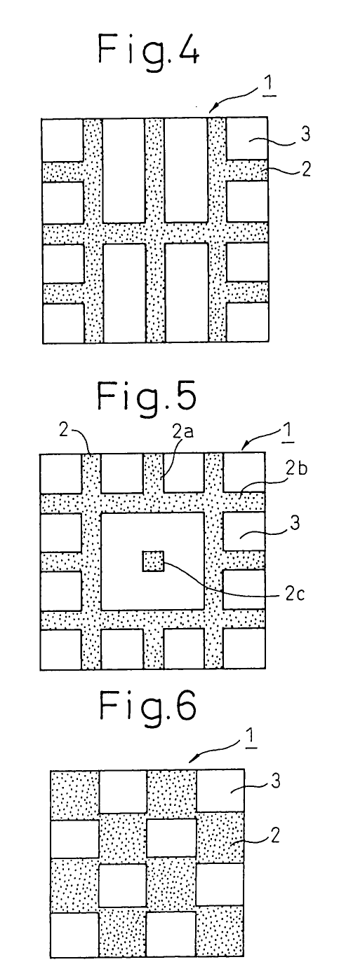

In the pattern of a warmth-retaining fabric 1 shown in FIG. 4, the lattice pattern of a warmth-retaining layer 2 lacks part of the transverse stripes 2b in a proportion of one out of two stripes, and part of the longitudinal stripes 2a in a proportion of one out of four stripes. Exposed portions 3 of the substrate are formed among the longitudinal stripes 2a and transverse stripes 2b. In the warmth-retaining fabric shown in FIG. 4, the entire warmth-retaining layer (100%) forms a continuous region.

In the pattern of a warmth-retaining fabric 1 shown in FIG. 5 a warmth-retaining layer 2 is formed into a lattice pattern, however, the lattice pattern lacks part of the longitudinal stripe portions 2a and part of the transverse stripe portions 2b to form an island-like independent portion 2c of the warmth-retaining layer in exposed portions 3 of the substrate. However, the area of the independent portion 2c is less than 25% of an entire area of the warmth-retaining layer.

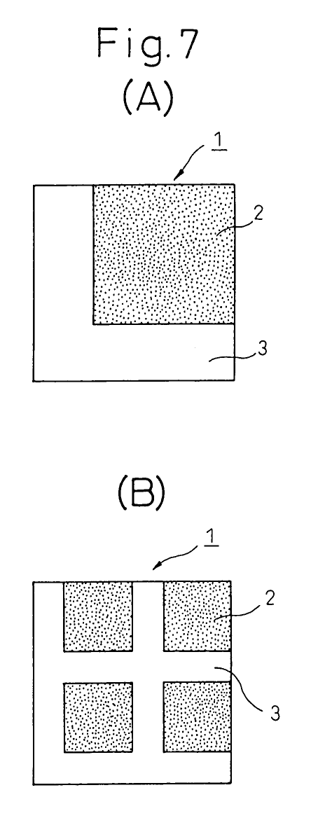

In the pattern of a warmth-retaining fabric 1 shown in FIG. 6, a warmth-retaining layer 2 and exposed portions 3 of the substrate are arranged to form a substantially lattice pattern. However, the warmth-retaining layer 2 in the pattern forms a mutually continued continuous region; on the other hand, the exposed portions 3 of the substrate are formed into a plurality of discontinuous regions. That is, the side length of a square unit portion forming the warmth-retaining layer 2 substantially having a lattice pattern is designed to be longer than that of a square unit forming the discontinuous exposed portions 3 of the substrate. All the square units of the warmth-retaining layer in this case constitute a continuous region.

FIG. 7 shows an example of a warmth-retaining fabric different from that of the present invention. In a repeating unit of a pattern of a fabric 1 shown in FIG. 7 (A), one square warmth-retaining layer 2 is formed in the upper right corner, and an L-shaped exposed portion 3 of the substrate is formed on the left and bottom sides. The ratio of an area of the warmth-retaining layer 2 to a total area of the repeating unit of the pattern, namely, the surface coverage is 50%, and the warmth-retaining layer 2 is in the form of one continuous region. When the repeating unit of the pattern in FIG. 7(A) is repeated in the longitudinal and transverse directions, the exposed portions 3 of the substrate are mutually continued in the longitudinal and transverse directions to form a lattice continuous region composed of longitudinal and transverse stripes intersecting each other. However, each of the warmth-retaining layers 2 in the repeating units of the pattern is surrounded by, and isolated from, the continuous lattice exposed portion 3 of the substrate, and the warmth-retaining layers 2 are not continued to each other in the longitudinal and transverse directions.

For the warmth-retaining fabric of the present invention, there is no specific limitation to the type (structure), dimension (thickness), basis weight and shape of the substrate-forming fabric. At least one type of fibers selected from synthetic fibers, for example, polyester fibers and nylon fibers; regenerated fibers, for example, rayon; natural fibers, for example, cotton, wool and fibers silk; and a semi-synthetic fibers, for example, cellulose triacetate fibers. The artificial fibers may either be in the form of filaments or a staple fibers. The fabrics formed from the above-mentioned fibers can be selected from woven fabrics, knitted fabrics, unwoven fabrics and composite fabrics of these fabrics.

For the warmth-retaining fabric of the present invention, a warmth-retaining layer containing an infrared ray-absorber and a binder resin is firmly bonded to at least one surface of the substrate so that 30 to 85% of the area of the substrate surface is coated therewith. In the warmth-retaining fabric of the present invention, the warmth-retaining layer may be firmly bonded to either both surfaces or only one surface of the substrate. However, it is preferred that the warmth-retaining layer be firmly bonded to the one surface alone. That is, the warmth-retaining layer is firmly bonded to the one surface alone of the substrate, and this side of surface is used as the back surface of the warmth-retaining fabric. When the warmth-retaining fabric is used for clothing, the fabric is used in such a manner that the warmth-retaining layer-bonded surface faces the skin of a human body. In thus case, even when the warmth-retaining layer is colored, the colored warmth-retaining layer does not appear on the front surface of the fabric, and as a result, no problem in appearance of the fabric occurs. Furthermore, when the warmth-retaining layer containing an infrared ray absorber is firmly bonded to only the back surface, heat generated in the human body is hardly propagated and radiated from the back surface to the front surface of the fabric, and as a result, the warmth-retaining efficiency of the fabric can be enhanced.

There is no specific restriction to the type of the infrared ray absorber contained in the warmth-retaining layer of the warmth-retaining fabric of the present invention as long as the infrared ray absorber is a substance having an absorption of 10% or more in the infrared ray band with a wavelength of from 700 to 2,000 nm. For example, the infrared ray absorber can be selected from fine metal oxide particles, carbon black, infrared ray-absorbing organic coloring materials and the like. Among the above-mentioned infrared ray absorbers, an infrared ray absorber having a thermal conductivity of 10 W/m·K (at 27° C.) or more, more preferably 20 W/m·K or more is preferred. When the infrared ray absorber having a thermal conductivity in the above-mentioned range is warmed by infrared rays of the sunlight or others the fabric substrate is extremely rapidly warmed and the warmth-retaining fabric exhibits an excellent warmth-retaining performance. As the heat conductive infrared ray absorber, fine particles of metal oxide, for example, antimony-doped tin oxide (ATO) and tin-doped indium oxide (ITO) are preferably used. The fine particles preferably have an average particle size of 100 nm or less. The above-mentioned metal oxide particles are transparent materials which allow visible rays to transmit therethrough; therefore, the particles are preferred because they do not change the color of the warmth-retaining layer. Fine particles of the metal oxide are available as an aqueous dispersion or a dispersion in a solvent, for example, toluene. Moreover, when the color of a fabric substrate is a dark color such as black, navy blue or dark red, carbon black can also be appropriately used as a heat conductive infrared ray absorber. The particle size of heat conductive infrared ray-absorbing carbon black may be 10 μm or less, preferably from 0.01 to 1.0 μm. In addition, when the color density of the substrate fabric is low, use of carbon black in a warmth-retaining layer may cause the exposed portion of the substrate to be stained grayish.

The amount of an infrared ray absorber contained in the warmth-retaining layer bonded to the substrate is preferably from 0.02 to 50 g, more preferably from 0.5 to 20 g, per m² of the substrate. When the amount of an infrared ray absorber firmly bonded thereto is less than 0.02 g/m², irradiation of infrared rays of sunlight, etc. onto the warmth-retaining fabric, may not adequately warm the fabric. Conversely, when the amount of an infrared ray absorber bonded thereto is larger than 50 g/m², while the resultant fabric shows a sufficient warmth-retaining effect, the effect may be saturated, and an economical disadvantage may occur.

In the warmth-retaining fabric of the present invention, the binder resin for the warmth-retaining layer includes, for example, urethane resin, acrylic resin, polyester resin, silicone resin, vinyl chloride resin and/or nylon resin. The dry solid amount of the bonded binder resin is preferably from 0.01 to 40 g/m², more preferably from 5 to 30 g/m² on the substrate surface.

The infrared ray absorber and binder resin mentioned above are mixed in a medium in advance, and the surface of the substrate is printed in a predetermined pattern with the resultant dispersion of the mixture and dried. As a medium for the dispersion, water or an organic solvent is used. In view of the operation environment, in the processing procedure, an aqueous solvent is preferably used as a dispersion medium. The organic solvent includes, for example, toluene, isopropyl alcohol, dimethylformamide, methylethylketone and/or ethyl acetate. A cross-linking agent, for example, an epoxy cross-linking agent, may be used in combination with the infrared ray absorber-binder resin dispersion. Further, to improve the adhesion of the warmth-retaining layer to the substrate, suitable additives, for example, a surfactant which increases the affinity of the dispersion to the substrate may further be incorporated into the liquid dispersion. Examples of the surfactant include fluorine-containing surfactants (perfluoroalkylcarboxylic acid salt), quaternary ammonium salt cationic surfactants, sulfonic acid type anionic surfactants and betaine type ampholytic surfactants.

The blending ratio in dry solid weight of the above-mentioned infrared absorber to the binder resin is preferably from 1:0.5 to 1:50, more preferably from 1:5 to 1:40. When the blending ratio exceeds 1/0.5, the infrared ray absorber may be removed when the warmth-retaining fabric thus obtained is laundered, and durability in the warmth-retaining property of the fabric to laundering may be insufficient. Moreover, when the blending ratio is less than 1/50, the effect of the binder resin exerted on the durability to laundering is saturated, and an economical disadvantage may occur.

In the warmth-retaining fabric of the present invention, the warmth-retaining layer coating 30 to 85% of the surface area of the substrate, and portions of the substrate not coated with the warmth-retaining layer, namely, exposed portions of the substrate, are arranged in accordance with a repeating unit of a pattern which is repeated in the longitudinal direction of the warmth-retaining fabric. In the repeating unit of a pattern, the warmth-retaining layer includes continuous regions in an area of 25% or more preferably 40% or more, more preferably from 50 to 100% based on the entire area of the layer. Examples of the repeating unit of a pattern formed from a warmth-retaining layer and exposed portions of the substrate are shown in FIGS. 1 to 6.

A warmth-retaining layer in repeating units of a pattern of the warmth-retaining fabric of the present invention is preferably formed in, for example, a continuous lattice pattern as shown in FIG. 3. In this case, the clearance between longitudinal stripes and that between transverse stripes are each preferably from 2 to 30 mm. As a result of forming a continuous region of a warmth-retaining layer as explained above, when the infrared ray absorber is heated by infrared rays of the sunlight, etc., the heat is rapidly transferred through the lattice warmth-retaining layer to quickly warm the fabric substrate. Moreover, the ratio of a total area of the warmth-retaining layer to the entire substrate surface area is from 30 to 85%, preferably from 45 to 75%.

When the above-mentioned area ratio of the warmth-retaining layer is less than 30%, irradiation of the infrared rays to the warmth-retaining layer cannot fully warm the fabric substrate. Moreover, when the area ratio exceeds 85%, the resultant warmth-retaining fabric has a stiff hand and has an unsatisfactory touch. Furthermore, even when the warmth-retaining layer is formed in an area ratio of from 30 to 85%, if the ratio of the total area of a continuous region in the warmth-retaining layer to the total area of the warmth-retaining layer is less than 25%, the resultant warmth-retaining fabric may unsatisfactory. To form a warmth-retaining layer containing an infrared ray absorber and a binder resin on the substrate of a fabric (to become a warmth-retaining fabric), the infrared ray absorber and the binder resin are mixed in the blending ratio as explained above to give a coating liquid having a desired concentration. A desired surface (preferably the back surface) of the substrate is coated with the coating liquid by gravure coating or screen printing method, and dried.

When the infrared ray absorber in the warmth-retaining layer of the warmth-retaining fabric of the present invention is heated with infrared rays of sunlight, etc., the heat permeates through the continuously connected warmth-retaining layer region, and the fabric is rapidly warmed within a short period of time. As a result of the above-mentioned action, the warmth-retaining fabric of the invention shows an excellent warmth-retaining performance. Moreover, because the warmth-retaining layer containing an infrared ray absorber and the exposed portions of the substrate are distributed in accordance with a desired pattern of the warmth-retaining fabric of the present invention, the hand of the substrate is less impaired in comparison with a conventional warmth-retaining fabric in which a warmth-retaining layer is formed on the entire surface of a substrate. Furthermore, the warmth-retaining fabric of the present invention can be less colored with an infrared ray absorber, to have a pale color, in comparison with a conventional warmth-retaining fabric prepared from synthetic fibers into which an infrared ray absorber is mixed by kneading.

In the warmth-retaining fabric of the present invention, prior to or subsequent to forming a warmth-retaining layer, a surface of the substrate fabric on which a warmth-retaining layer is formed and/or another surface on which the warmth-retaining layer is not formed are subjected to at least one function-imparting treatment selected from a water absorption treatment; a water-repellent treatment; a raising (gigging) treatment; a color-deepening treatment; a stain-proofing treatment; an ultraviolet ray-shielding treatment; an antistatic treatment; an antibacterial agent treatment; a deodorant treatment; a mothproofing agent treatment; a luminous storage agent treatment; and a light returning and reflecting agent treatment.

### EXAMPLES

The present invention will be further explained by the following examples. However, the present invention is in no way restricted thereby. In addition, measured items in the examples are measured by the following procedures.

(1) Warmth-Retaining Property

In order to confirm a warmth-retaining effect, a test sample is placed in a constant temperature and constant humidity environment at 20° C. at 60% RH, and irradiated with infrared rays by using a 200-W reflecting lamp light source used as an energy source located 50 cm above the test sample. The surface temperature of the test sample is measured 30 sec after the irradiation by using an infrared ray sensor (trademark; THERMOVIEWER, manufactured by NIHON DENSHI K. K.); and, simultaneously, the back surface temperature of the sample is measured by using a thermocouple.

(2) Evaluation of Hand

Three panelists conducted an organoleptic test for a soft feeling of a test sample, and evaluated the test results of the sample in accordance with the following criteria.

Extremely excellent: class 4

Excellent: class 3

Good (practically usable): class 2

Not good: class 1

### Example 1

Using poly(ethylene terephthalate) multifilament yarns having a yarn count of 56 dtex/20 fil. as warp yarns and poly(ethylene terephthalate) multifilament yarns having a yarn count of 84 dtex/36 fil. as weft yarns, a taffeta woven fabric having the following weave structure was prepared: a warp yarn density of 76 yarns/2.54 cm and a weft yarn density of 90 yarns/2.54 cm.

The taffeta woven fabric was scoured, relaxed, dyed black color, dried, and heat set to provide a woven fabric substrate.

Furthermore, a coating liquid for a warmth-retaining layer was prepared according in the following composition.

| Component | Wt. % |
|---|---|
| Acrylic resin binder (dry solid | 60.0 |
| content: 40%) | |
| Aqueous dispersion of ATO (dry solid | 5.0 |
| content: 15%, heat conductivity of ATO: | |
| 50 W/m · K, fine particle size of ATO: | |
| 50 nm or less) | |
| Water | 35.0 |

Note:
ATO: antimony-doped tin oxide

Then, one side surface of the taffeta woven fabric was coated with the coating liquid using a gravure roll of 105 mesh. (The coating amount of ATO per repeating unit area was 0.8 g/m², and the dry solid amount of the coated binder resin was 24.2 g/m².) The coating liquid layer was dried at 160° C. to form a warmth-retaining layer, and a warmth-retaining fabric was obtained. The repeating unit of printing pattern with the coating liquid by the gravure roll was the lattice pattern shown in FIG. 3(B) (area ratio of the warmth-retaining layer: 50%, clearance between longitudinal stripes: 10 mm, clearance between transverse stripes: 10 mm, an area ratio of the warmth-retaining layer continuous region: 100%). Table 1 shows the warmth-retaining property and the hand of the resultant warmth-retaining fabric. Both the warmth-retaining property and the hand of fabric were good.

### Comparative Example 1

A warmth-retaining fabric was prepared by the same procedures as in Example 1 except that a surface of the taffeta woven fabric was entirely coated with the coating liquid by using a gravure roll in an area coverage of the warmth-retaining layer of 100%. The dry solid amount of the coated ATO per repeating unit area was 1.6 g/m², and the dry solid amount of the coated binder resin was 48.4 g/m². Table 1 shows the warmth-retaining property and the resultant hand of the warmth-retaining fabric. Although the warmth-retaining property of the warmth-retaining fabric was good, the woven fabric exhibited a high stiffness and an unsatisfactory hand.

### Comparative Example 2

A warmth-retaining fabric was prepared by the same procedures as in Example 1 except that the pattern of the coating liquid layer to be transferred by a gravure printing roll was formed as shown in FIG. 7(B). The repeating unit of the pattern is shown in FIG. 7(A). In FIG. 7(A), the ratio of the area of the warmth-retaining layer to the area of the repeating unit of the pattern was 50%, and the warmth-retaining layer was in the form of an integrated continuous region (area ratio: 100%). However, when the repeating unit of the pattern in FIG. 7 (A) was repeated in the longitudinal and transverse directions, warmth-retaining layers 2 in the repeating units adjacent to each other were not continuous with each other.

The amount of the coated ATO and that of the coated binder resin (solid component) in the repeating unit of the pattern were 0.8 g/m² and 24.2 g/m², respectively.

Table 1 shows the test results on the warmth-retaining property and hand of the resultant warmth-retaining fabric.

TABLE 1

| | | | Comparative | Comparative |
|---|---|---|---|---|
| | | Example 1 | Example 1 | Example 2 |
| Coating amount of infrared ray | | 0.8 | 1.6 | 0.8 |
| absorber (g/m²) | | | | |
| Warmth- | Temperature of | 38.2 | 38.5 | 34.1 |
| retaining | front surface of | | | |
| property | fabric (° C.) | | | |
| | Temperature of | 39.2 | 39.8 | 34.2 |
| | back surface of | | | |
| | fabric (° C.) | | | |
| Hand of fabric | Soft hand | ◯ | X | ◯ |

In Comparative Example 1 in which the entire surface of the substrate was coated with a warmth-retaining coating layer, while the coating amount of the infrared ray absorber was 1.6 g/m², and the warmth-retaining property was good, the hand was stiff and not good. In Example 1, while the coating amount of the infrared ray absorber was 0.8 g/m² which was a half of that in Comparative Example 1, the warmth-retaining property of the resultant fabric was substantially comparable to that in Comparative Example 1, and the hand of the resultant fabric was good. In Comparative Example 2, while the coating amount of the infrared ray absorber was the same as in Example 1, the warmth-retaining property was significantly poor in comparison with that in Example 1 because the warmth-retaining layers were not connected to each other.

### INDUSTRIAL APPLICABILITY

The warmth-retaining fabric of the present invention absorbs the infrared rays in sunlight, etc., with high efficiency and can convert the rays into heat with high efficiency, without impairing the original hand of the substrate fabric and with only slight change in the color of the substrate fabric, and exhibits an enhanced warmth-retaining performance. Accordingly, the warmth-retaining fabric of the present invention is significantly useful in practice.

1. A warmth-retaining fabric comprising a substrate comprising a fabric, and at least one warmth-retaining layer coated on at least one surface of the substrate with a coverage of 30 to 85% of the substrate surface area and comprising an infra-red ray-absorber and a binder resin, wherein
in repeating units of a pattern constituted from the warmth-retaining layer and exposed-portions of the substrate not coated by the warmth-retaining layer and repeated in at least one direction of the longitudinal and transverse directions of the substrate, the warmth-retaining layer has at least one continuous region having an area corresponding to 25% or more of the total area of the warmth-retaining layer, and the continuous regions of the warmth-retaining layers in the repeating pattern units adjacent each other in at least one direction of the longitudinal and transverse directions are continuous with each other.

2. The warmth-retaining fabric as claimed in claim 1, wherein the repeating unit of the pattern contains one or more exposed portions of the substrate, and the exposed portions are not continuous with each other in at least one direction of the longitudinal and transverse directions of the repeating units.

3. The warmth-retaining fabric as claimed in claim 2, wherein the non-continuous regions of the exposed portions of the substrate are distributed in the number of at least one per unit area of 10 cm×10 cm of the surface of the substrate.

4. The warmth-retaining fabric as claimed in claim 1, wherein the warmth-retaining layer is formed on only one surface of the substrate.

5. The warmth-retaining fabric as claimed in claim 1, wherein the infra-red ray-absorber has a thermal conductivity of 10 W/m·K or more, as determined at a temperature of 27° C.

6. The warmth-retaining fabric as claimed in claim 1 or 5, wherein the infra-red ray-absorber comprises fine particles of at least one member selected from infra-red ray-absorbing metal oxides, carbon black and infra-red ray-absorbing, coloring organic compound materials.

7. The warmth-retaining fabric as claimed in claim 6, wherein the infra-red ray-absorbing metal oxide fine particles are selected from fine particles of antimony-doped tin oxide and tin-doped indium oxide having an average particle size of 100 nm or less.

8. The warmth-retaining fabric as claimed in any one of claims 1 and 5 to 7, wherein the infra-red ray-absorber is contained in a content in the range of 0.02 to 50 g/m² in the warmth-retaining layer on the surface of the substrate.

9. The warmth-retaining fabric as claimed in claim 1, wherein the mass ratio of the infra-red ray-absorber to the binder resin contained in the warmth-retaining layer is in the range of 1:0.5 to 1:50.

10. The warmth-retaining fabric as claimed in claim 1, wherein, in the repeating pattern unit on the surface of the substrate, the warmth-retaining layer is in the form of a continuous lattice pattern constituted from a plurality of longitudinal stripes extending in parallel to each other in the longitudinal direction of the substrate and a plurality of transverse strips extending in parallel to each other in the transverse direction of the substrate and intersecting the longitudinal stripes.
